(19) United States
(12) Patent Application Publication
(10) Pub. No.: US 2012/0066551 A1
(43) Pub. Date: Mar. 15, 2012

(54) Run-time Verification of CPU Operation

(76) Inventors: Alexandre Palus, Sugar Land, TX (US); Karl Friedrich Greb, Missouri City, TX (US); Balatripura Sodemma Chavali, Sugar Land, TX (US)

(21) Appl. No.: 12/883,034

(22) Filed: Sep. 15, 2010

(51) Int. Cl. G06F 11/07

(52) U.S. Cl. 714/39; 714/37; 714/E11.024

(57) ABSTRACT

Safe operation in a processor may be verified by making use of an execution trace module that is normally only used for testing and software development. During operation of the processor in the field, a sequence of instructions may be executed the processor. A portion of the execution is traced to form a sequence of trace data. The sequence of trace data is compressed to form a checksum. The checksum is compared to a reference checksum, and an execution error is indicated when the checksum does not match the reference checksum.

### FIELD OF THE INVENTION

This invention generally relates to verification of correct operation of complex integrated circuits and in particular to correct operation of safety critical systems.

### BACKGROUND OF THE INVENTION

Fault-tolerance or graceful degradation is the property that enables a computer based system to continue operating properly in the event of the failure of some of its components. A failure detection mechanism is generally required to enable use of complex CPUs in safety critical systems, such as automotive, aerospace, industrial, medical, etc. For simple CPUs, this has traditionally been done by the use of online software based testing or by a full duplication of CPUs with a compare of all outputs, which is also known as “lockstep” CPUs. The second CPU is effectively a real time hardware checker.

As the need for safety critical systems has expanded into embedded applications in automotive, aerospace, industrial, medical, etc., fault tolerant concepts are now employed within an application specific integrated circuit (ASIC) that provides a system on a chip (SOC). These embedded systems may include one or more processors or microcontrollers that may execute application software for controlling the operation of an automobile, airplane, process control system or medical device, for example.

### BRIEF DESCRIPTION OF THE DRAWINGS

Embodiments in accordance with the invention will now be described, by way of example only, and with reference to the accompanying drawings:

FIG. 1 is a block diagram illustrating a exemplary application specific integrated circuit (ASIC) with an instruction/data trace module (IDTM) and checksum module;

FIG. 2 is a block diagram illustrating a multiprocessor system with multiple processor cores each having an IDTM and checksum module;

FIG. 3 is a flow diagram illustrating verification of correct system operation by tracing program execution to generate a checksum; and

FIG. 4 is a more detailed flow diagram illustrating verification of correct system operation in a synchronous multiprocessor system by tracing program execution to generate a checksum.

### DETAILED DESCRIPTION OF EMBODIMENTS OF THE INVENTION

With very complex central processing units (CPUs), the standard methods for providing assurance of correct operation in safety critical systems are not optimum for cost effective solutions. Software cannot address the additional complexity of a modern CPU and provide adequate diagnostic coverage for a real time application. Real time applications have timing constraints that must be meet in order for the system to operate correctly. Lockstep solutions are still viable from a detection perspective, but increase in cost and power consumption as the complexity of a CPU increases.

On modern complex CPUs, information on the flow of instructions and the data operated upon by the CPU may be traced and exported to debug modules to aid in software development. Various capabilities for instruction tracing are provided for processors. For example, a test system provided by Texas Instruments, “Code Composer Studio,” uses a trace buffer included within a microprocessor to trace program execution by recording address traces and occurrences of discontinuities in an instruction execution sequence, such as by taking a jump or receiving an interrupt. During application operation, these debug modules are not used for software development, but the trace information may still be generated by the CPU. On ARM based CPUs from ARM Computers, Inc, a program trace macrocell (PTM) can trace and provide both instruction and data trace. Other microcontroller providers, such as Infineon, Freescale, STMicroelectronics, and Renesas, have similar real-time, non-intrusive trace capabilities on their microcontrollers.

An embodiment of the present invention uses the debug and trace information from a CPU to provide a safety diagnostic. The internal trace port is sampled to generate a CRC or other checksum by hardware. The generated checksum is compared to an expected “golden” checksum, and, when matched, there is a very strong indication that the program sequence/flow executed by the CPU currently is the same as the flow which was intended when the golden checksum was developed. Typically, in safety applications all code which will ever run on the product is fixed at product deployment, so it is possible (and even mandatory) that pre-release validation consider all possible operating states of the CPU, in which case the expected flow and golden checksums can easily be generated. If a failure is detected during operation, it is also possible to capture the CPU's exported trace information to a memory buffer for off-line analysis and forensic investigation of the processor failure. Thus, in this embodiment, a system that uses only a single processor core may benefit from enhanced safety diagnostic capability.

In another embodiment, multiple CPU processing clusters may benefit from enhanced safety diagnostic capability. The current trend in the industry is to use multiple medium to high complexity processors in homogeneous, symmetric multi-processing (SMP) clusters. From an operating system standpoint, these can be considered a single virtual CPU and tasks can be distributed amongst the physical CPUs to optimize performance and power. These systems are common in desktop machines and mobile devices, but are in their infancy in the safety critical application space.

When using an SMP system for safety critical operation, short comings of software based checking and lockstep solutions are amplified due to increased numbers of CPUs. Embodiments of a safety diagnostic across multiple CPUs based on execution tracing provide a cost effective solution. The safety function can be executed on two or more CPUs in the cluster with an independent checksum developed from the trace export of each execution. If the checksums of both operations match, there is a strong indication that the CPUs are operating properly. In this embodiment, there is no need to develop a golden checksum since it is done in real-time based on the first calculation. Time diversity may also be allowed, as it is not necessary to execute the safety function on both CPUs at the same time while the checksum is developed on each one independently. This helps to reduce the possibility of a common cause failure affecting both execution units.

In another embodiment, the same technique is applied to multiple executions of the safety function with the same data on a single CPU. When used in conjunction with execution across multiple CPUs in a cluster, this allows a malfunctioning CPU to be identified, shut down, and operation continued in limited fashion with a reduced number of execution units. This provides continued availability for critical applications. For example, continued availability is required in an automotive system that relies on fully electronic systems for drive-train control such as e-throttle, e-brake, etc. in place of a mechanical system.

Examples of faults that may be detected using the innovative techniques described herein include:
Changes in program sequence that may be seen by differences in instruction address information;
Changes in data input or output from the core that may be seen by changes in the core data trace information;
Faults in the CPU clock which result in slower or faster execution;
etc.

Both hard and soft faults may be detectable. Note both faults inside the CPU and faults outside the CPU which result in a change in CPU operation (i.e. CPU memories, interconnect, etc.) may be detectable. In this manner, embodiments of the invention provide a mechanism to detect erroneous operation and to enable fail-safe behavior.

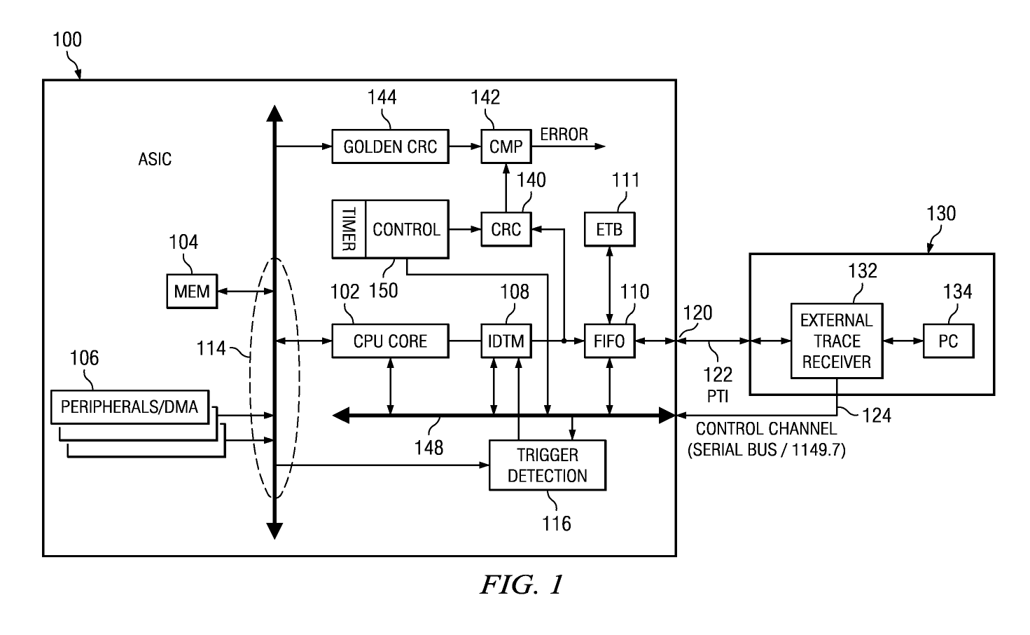

FIG. 1 is a block diagram illustrating an exemplary application specific integrated circuit (ASIC) 100 with an instruction/data trace module (IDTM) 108 closely coupled to central processing unit (CPU) core 102. For purposes of this disclosure, the somewhat generic term “ASIC” is used to apply to any complex system on a chip (SOC) that may include one or more processing modules 102, memory 104, and/or peripherals and DMA (direct memory access) controllers 106. At least a portion of memory module 104 may be non-volatile and hold instruction programs that are executed by processing modules 102 to perform the system applications. Each CPU may also include embedded memory and/or caches.

IDTM 108 is coupled to the CPU core 102 and has access to various internal buses so that it can monitor the progress of instruction execution. It evaluates instructions that may cause program execution to jump out of line, such as branch instructions, conditional branch instructions, returns, etc. It also monitors for interrupts and other exception events that may cause program execution to jump to a new location. IDTM 108 also monitors clock circuitry within CPU core 102 so that it can count the number of processor cycles between each execution event. Typically, a processor cycle is the smallest unit of time and corresponds to one cycle of the processor instruction pipeline execution. In some embodiments, the IDTM may trace processor and/or system events, such error events, cache miss, power setting changes, etc.

In order to test and debug a new application specific integrated circuit (ASIC) or a new or modified application program running on an ASIC, various events that occur during execution of an application or a test program are traced and made available to an external test device for analysis. The trace report typically includes trace data representative of a sequence of execution events that indentifies each discontinuity in program execution. Time stamps may be included with each execution event, and stand alone time stamps may also be provided to enable the external test device to determine approximately how long it takes to execute various pieces of the application or test code.

When an external test system 130 is connected to ASIC 100 via interconnect 122, IDTM 108 may transmit sequences of trace events and time stamps directly to external trace receiver 132 as they are received. Interconnect 122 may include signal traces on a circuit board or other substrate on which ASIC 100 is mounted and may be connected to a parallel trace interface (PTI) 120 provided by ASIC 100. Interconnect 122 may include a connector to which a cable or other means of connecting to external trace receiver 132 is coupled. A control channel 124 such as a serial bus or P1149.7 may be used to provide control information from external trace device 130 to ASIC 100.

Test system 130 generally includes one or more processors, such as processor 134, and a user interface that allows a test engineer, for example, to control, monitor, and evaluate execution of programs and the resulting trace data on ASIC 100. In a typical scenario, the test system has a copy of the program that is being executed by ASIC 100. A trace event is generally produced for each jump or branch instruction that is processed by ASIC 100 and indicates how the program execution sequence is affected by the jump or branch instructions. Similarly, a trace event is produced for other events such as an interrupt or exception event that changes the execution stream. For example, if a conditional branch is taken, this fact is included in the trace event produced by execution of the conditional branch instruction. The test system can determine the branch address by analyzing the program code. If the conditional branch is not taken, then this fact is included in the trace event. For interrupts and exceptions, the trace event needs to include the resulting address of where instruction execution is transferred so that the test system can know where to refocus its code analysis. If a long stretch of code is executed inline, IDTM 108 may insert periodic synchronization events to indicate to the test system where the current execution point is. Similarly, IDTM 108 may also generate standalone timestamp events to help the test system in correlating the instruction execution, especially if multiple instruction streams from multiple processors on ASIC 100 are being traced.

As trace events are received at test system 130, they are correlated to the instructions in the program and can then be displayed to the test engineer to indicate exactly what code is being executed and, by using the time stamps, how long it takes to execute a particular piece of instruction code. The general operation of test systems is generally well known and will not be described further herein.

In this embodiment, an elastic first-in first-out (FIFO) buffer 110 is coupled between IDTM 108 and parallel trace interface (PTI) 120. In some embodiments, FIFO 110 may be small, such as only a few entries. In other embodiments, FIFO 110 may provide storage for several hundred or several thousand trace events and associated time stamps and cycle count data.

When the SOC is not connected to an external trace receiver, IDTM 108 within ASIC 100 may transmit the sequences of trace data and associated time stamps to an embedded trace buffer (ETB) 111 within ASIC 100 via an internal bus or other interconnect. The ETB 111 may be coupled to FIFO 110, as shown, or may be coupled in parallel with FIFO 110, or even coupled to the output of FIFO 110 in various embodiments. In another embodiment, FIFO 110 is not included and ETB 111 is coupled to an output of IDTM 108. In this manner, at a later time the contents of ETB 111 may be transferred to another device by using another interface included within ASIC 100, such as via a USB (universal serial bus) for example. Alternatively, an external trace receiver may be connected to the ASIC at a later time and the contents of the ETB 111 may be accessed and then transmitted to the external trace device.

As discussed earlier, during application operation, these debug modules are not used for software development, but the trace information may still be generated by the CPU. An embodiment of the present invention uses the debug and trace information from a CPU to provide a safety diagnostic. During normal system operation when ASIC 100 is not connected to the test system, ASIC 100 may be set up to execute one or more programs on its one or more processing modules. Execution may proceed for a while without being traced. A particular action, which may be set up by control function 150, may trigger tracing to begin. Control function 150 may be implemented as a software routine executed by CPU core 102 or it may be implemented as a separate hardware module or microcontroller, for example. The trigger may be in response to executing from a particular address, storing or fetching data from a particular address, or similar types of events that are supported by trigger detection circuitry 116 within ASIC 100. Trigger circuitry 116 may be coupled to one or more address and/or data buses within ASIC 100, as indicated at 114. Control function 150 may set up trigger circuitry 116 via control bus 148 to generate a trigger event based on a specific data occurrence, address occurrence, etc. Further, each trigger event may cause a register or set of registers to be accessed for a programming model that may define an action to be taken upon detection of the trigger event. Trigger detection is transparent to the program execution and does not cause program execution to halt or to slow down.

As discussed earlier, embodiments of the invention also include a checksum computation module 140 that is coupled to an output of IDTM 108. Checksum module 140 monitors the trace data captured by IDTM 108 and compresses a sequence of trace data into a compact representation by performing a polynomial code checksum, also referred to as a cyclic redundancy check (CRC), operation. CRC module 140 accepts data streams of any length from IDTM 108 as input but outputs a fixed-length CRC code. Its computation resembles a polynomial long division operation in which the quotient is discarded and the remainder becomes the result, with the important distinction that the polynomial coefficients are calculated according to the carry-less arithmetic of a finite field. The length of the remainder is less than the length of the divisor (called the generator polynomial), which therefore determines how long the result can be. The definition of a particular CRC specifies the divisor to be used, among other things.

Other embodiments of the invention may use other compression techniques, now known or later developed, to compress the trace sequence to a single check value. For example, a simple checksum may be produced by simple addition of the sequence of trace data with no or limited overflow. Other embodiments may use a Fletcher checksum, or an Adler checksum, for example. In another embodiment, the checksum module may be coupled to one or more buses and form a checksum from data observed on those buses without the use of a trace module.

Checksum storage module 144 is preloaded with a pre-calculated CRC value that is referred to as a “golden CRC” value. The golden CRC value is formed by executing the application program on a test system that is similar or identical to a production unit with a known good processor. A particular section or module of the application program is identified as being critical or indicative of correct operation of the system. A trigger is set up to cause this particular section to be traced, and a second trigger is set up to end the tracing to form a sequence of trace data. The sequence of trace data is then converted to the golden CRC and stored in checksum storage module 144.

In this embodiment, storage module 144 is a non-volatile storage device that is preloaded when the application program is installed in ASIC 100. This may be when ASIC 100 is manufactured, or when ASIC 100 is loaded with software. In another embodiment, storage module 144 may be a register, or other volatile memory, that is loaded from another non-volatile source within ASIC 100 by CPU core 102 or received via one of peripherals 106 from an external source, for example.

Comparison logic 142 compares a checksum formed by CRC module 140 during normal operation of ASIC 100 with the reference checksum stored in storage module 144. As part of the normal operation of ASIC 100, triggers are set up to trace the exact same portion of the application program that was used to form the reference CRC. Thus, each time this portion of the application program is executed, a sequence of trace data is traced by IDTM 108 and provided to CRC computation module 108 to form a checksum that is then compared to the reference checksum. An error is indicated when the calculated checksum from CRC computation module 140 does not match the reference checksum.

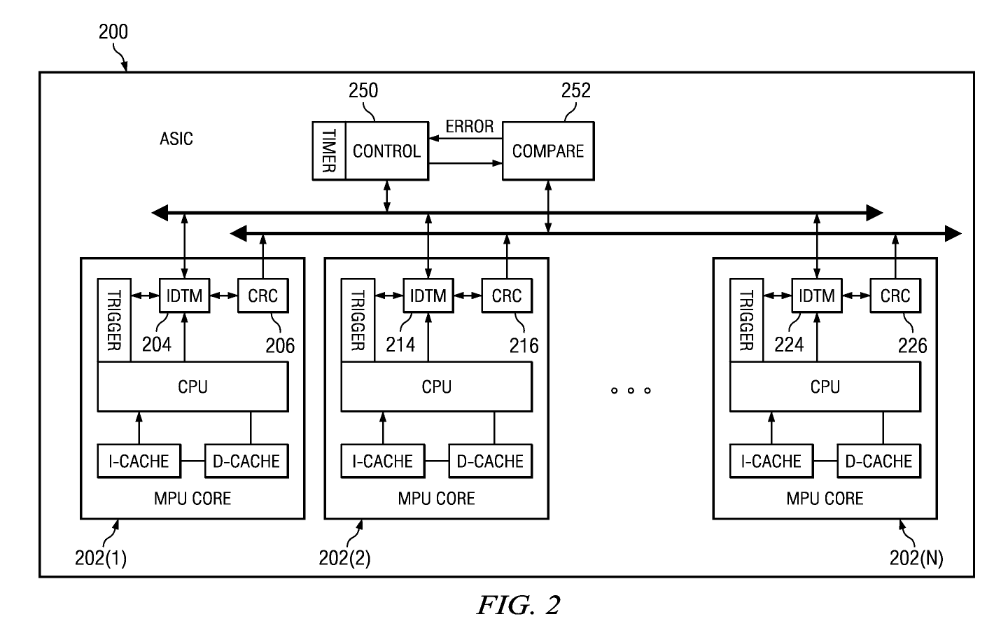

FIG. 2 is a block diagram illustrating a multiprocessor system 200 with multiple processor cores 202(1)-202(N) each having an IDTM 204, 214, 224 and checksum module 206, 216, 226. ASIC 200 may also include system memory modules, control modules, bus interfaces, etc. to provide a complete SOC. In various embodiments, additional system resources may be located on other integrated circuits that are coupled to ASIC 200.

ASIC 200 is an example of a homogeneous, symmetric multi processing (SMP) cluster for use in a safety critical application space. Each individual processor core operates similarly to the processor core described in FIG. 1 and each can trace a portion of the execution of an application program in response to a trigger condition to form a sequence of trace data and then compress the sequence of trace data to form a check value. Each processor core includes trigger logic that monitors various buses within the core, similar to that described in FIG. 1.

When using SMP system 200 for safety critical operation, a trace snooping based safety diagnostic across multiple CPUs may be used for detecting system faults. The safety function can be executed on two or more CPUs in the cluster with an independent CRC developed from the trace export of each execution. Compare module 252 compares the checksum for each CPU that is executing the safety function. If the CRCs of both operations match, there is a strong indication that the CPUs are operating properly; otherwise an error is indicated when they don't match.

Control function 250 may be embodied as a dedicated module that is programmed set up the trigger logic on each processor core in order to trace the selected portion of the safety function. Control function 250 then configures compare module 252 to compare the checksum values from the appropriate processor core. In some embodiments, control function 250 may be implemented by program code executed by one of the processor cores or by a separate processor or controller.

In an SMP embodiment, there is no need to develop a golden checksum since a real-time based checksum is produced by each processor core that is executing the critical portion of the sequence of instruction execution. Time diversity may also be allowed, as it is not necessary to execute the safety function on each CPU at exactly the same time while the CRC is developed on each one independently. Time diversity removes the need to reset all CPUs to resynchronize prefetch, cache control and branch prediction which can otherwise break lock step operation. This also helps to reduce the possibility of a common cause failure affecting all execution units.

Depending on the type of operation that is being verified, each core's unique CRC module is configured to capture one or more items, such as: intermediate algorithmic results written by CPU to CRC module; program trace interface output (provides program sequence monitoring); or event output pulses (typically used for hardware profiling). Upon completion of a safety critical task by all cores, or after a timeout for lack of completion, control logic 250 observes the result of the CRC comparison 252 to check pass/fail. One or a set of compares can effectively implement a one-out-of-two (1002), two-out-of-three (2003), or stronger voting system dynamically per task.

This solution for verifying correct CPU operation is primarily hardware based, runs in background, and only takes minimal cycles away from the CPU processing budget. This solution may be more size and power efficient than adding a lockstep checker core to each CPU in the cluster. This simplified solution compared to full lockstep may result in less loading on critical paths, and higher performance.

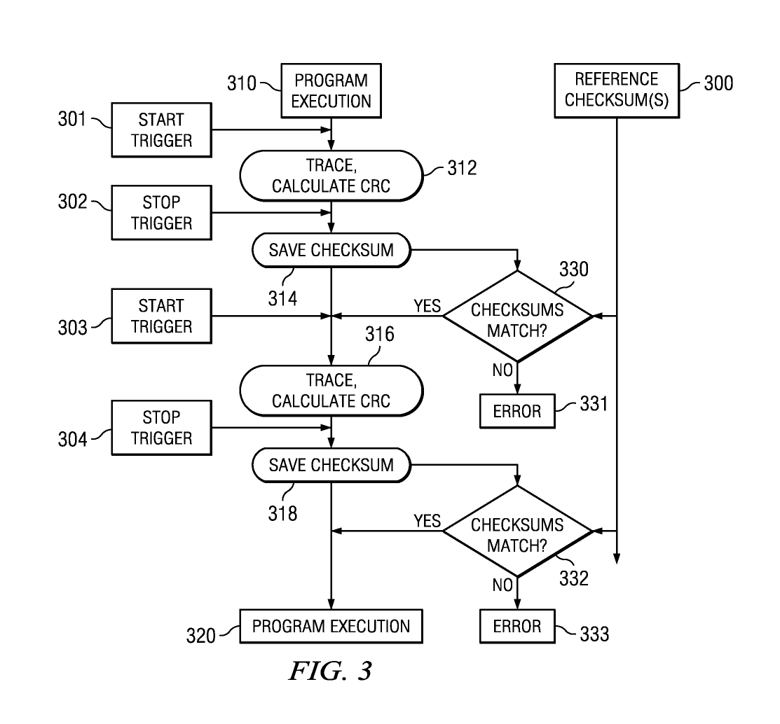

FIG. 3 is a flow diagram illustrating verification of correct system operation by tracing program execution to generate a checksum. The ASIC, such as ASIC 100 or ASIC 200, may be set up to execute one or more programs on its one or more processors during normal system operation it is not connected to a test system. A particular portion of code that is deterministic is designated as a safety test segment. A deterministic portion of code will always execute in the same sequence so that its checksum will remain constant. There may be one or more segments of code used to produce a corresponding set of one or more checksums.

If the system is a single processor system, the reference checksum(s) are produced and stored 300 for later use in the comparison process. The reference checksum(s) are produced by executing the same program using the same triggers, as will be discussed in more detail below. Typically, a golden checksum is produced on a test system and stored in each production unit prior to shipping for use during operation of the unit in the field. Alternatively, golden checksum(s) may be included with a software download that is received while the unit is in the field.

If the system is an SMP system, then the reference checksum(s) may be received from the companion processor(s).

Execution may proceed 310 for a while without being traced. A particular action, which may be set up by control function 150, 250 (see FIGS. 1 and 2), may trigger 301 tracing 312 to begin when a designated safety test segment begins execution. The trigger may be in response to executing from a particular address, storing or fetching data from a particular address, or similar types of events that are supported by trigger detection circuitry within the ASIC. Trigger circuitry may be coupled to one or more address and/or data buses within the ASIC. The control function may set up trigger circuitry associated with each CPU via a control bus to generate a trigger event based on a specific data occurrence, address occurrence, etc. Further, each trigger event may cause a register or set of registers to be accessed for a programming model that may define an action to be taken upon detection of the trigger event. Trigger detection is transparent to the program execution and does not cause program execution to halt or to slow down. Alternatively, there may be a command included in the instruction sequence being executed that causes the execution trace module to begin tracing.

Eventually, another trigger occurs, such as stop trigger 302. Trigger 302 may be in response to executing from a particular address, storing or fetching data from a particular address, or similar types of events that are supported by the trigger detection circuitry. While the tracing is being performed, a checksum is calculated 312 that includes each traced value, which may be an address, event type, data value, etc. When the trace is stopped, then the final checksum value is saved 314.

The saved checksum 314 is compared 330 to a reference checksum 300. If the system has identified more than one safety test segment of code that is being traced, then a checksum associated with the current trace sequence is used. Each start or stop trigger may include information in its associated programming model to identify the correct reference checksum, for example. If the saved checksum 314 and the reference checksum match, then there is good assurance that the system is operating correctly and operation continues. If they don't match, then there is a strong likelihood that a system error has occurred and an error 331 is indicated. Once an error is indicated, the system may enter a diagnostic mode, for example, in order to evaluate the error indication.

If more than one safety test segment of code has been identified, then another set of triggers 303, 304 may cause execution of that segment to be traced 316. As was described above, a checksum is saved 318, compared 332 to a respective reference checksum 300, and an error 333 signaled if there is a mismatch in the checksums.

In this manner, system execution may continue as long as no errors are detected. The same safety test segment(s) may be executed repeatedly and should produce the same respective checksum(s). Slight variations in timing due to cache faults or other system distractions should not cause a change in the checksum. However, in a system where exact timing is critical, then timing information, such as a cycle count, may be included in the checksum.

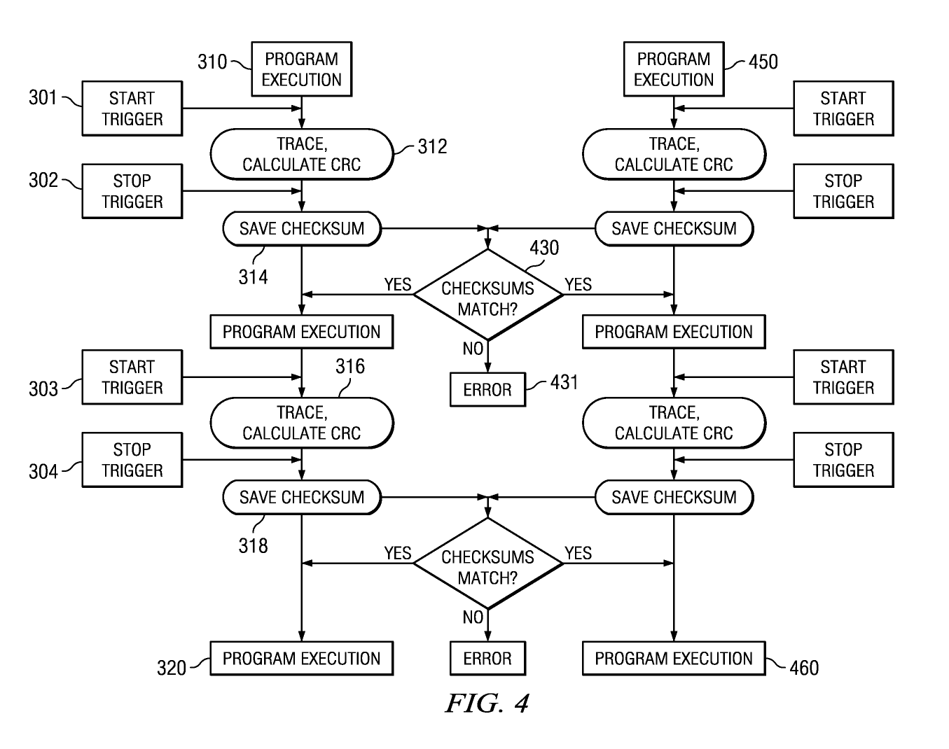

FIG. 4 is a more detailed flow diagram illustrating verification of correct system operation in an SMP system by tracing program execution to generate a checksum. FIG. 4 illustrates operation of two synchronous processors, but as mentioned earlier, three or more processor may participate in the process. Each processor executes the application program independently and execution tracings of safety test segments are made by each processor, as described above with regard to FIG. 3. In this illustration, one processor is executing a program sequence as indicated at 310-320 and a second processor is simultaneously executing the same program sequence as indicated at 450-460.

As each processor executes and traces a safety test segment, a checksum is generated by each processor core and compared to the checksum made by the other processor core(s). For example, checksum comparison 430 compares the checksums obtained after executing the safety test segment from program sequence 310 and from program sequence 450. If they match, both processors continue operation; but an error is indicated 431 if they don't match.

Time diversity may also be allowed, as it is not necessary to execute the safety function on both CPUs at the same time while the checksum is developed on each one independently. This helps to reduce the possibility of a common cause failure affecting both execution units. In terms of avoiding common cause failures, time diversity of even a few cycles (<1 us) is considered adequate in many embodiments.

When start/stop triggers are used on a specific task, there may be quite a bit of time diversity. The key parameter is the loop time of an application loop that is being traced, since for each check sum calculation the same input data should be used for the calculation. In an automotive application, the time diversity may be as much as 10-50 ms, for example. Time diversity beyond this range might result in operating on a different set of sensor input data that may produce an erroneous result. The exact amount of allowable time diversity thus depends on the parameters of the loop timing for a given application.

### Other Embodiments

Although the invention finds particular application to Digital Signal Processors (DSPs), implemented, for example, in an Application Specific Integrated Circuit (ASIC), it also finds application to other forms of processors. An ASIC may contain one or more megacells which each include custom designed functional circuits combined with pre-designed functional circuits provided by a design library.

While embodiments of the invention have been described, this description is not intended to be construed in a limiting sense. Various other embodiments of the invention will be apparent to persons skilled in the art upon reference to this description. For example, while various forms of checksums were described, the embodiments of invention are not limited to checksums. Any form of compression of a stream of data derived from executing an identified deterministic portion of code to form a relatively short, fixed length check value is envisioned. Thus, the term “checksum” as used herein is meant to cover any sort of fixed length check value.

In another embodiment, the checksum may be derived without the use of an execution trace module. In this case, a checksum generator may be coupled to one or more buses that carry system information, such as a program address bus, or a data bus. A control module may then be enabled by instructions embedded in the instruction sequence to start and stop the checksum formation, for example.

In another embodiment, events may be traced instead of, or in addition to, instruction and/or data tracing. For example, error events, cache miss events, interrupts, or any other type of processor or system event that is indicative of correct operation of the system may be traced and used to form a check value.

The checksum may be calculated by the CPU(s) that are executing the application, or may be calculated by a dedicated microcontroller, or other dedicated logic module that can perform the function of compressing the stream of trace data into a single data value.

While an instruction and data trace module was described herein, embodiments of the invention are not limited to a particular type of trace module. For example, a trace module that traces only instruction address may be used. Similarly, a trace of data accesses may be used. A trace of instructions may be use, etc. Embodiments of the invention may make use of any sequence of trace information that is derived by tracing a portion of the execution of a sequence of instructions.

In other embodiments, the same technique may be applied to multiple channel safety systems. For example, rather than just a one out of two voter, there may be a two out of three voter, a two out of two voter with a diagnostic channel, in conjunction with other diagnostics such as lockstep CPUs, etc.

In some embodiments, the ASIC may be mounted on a printed circuit board. In other embodiments, the ASIC may be mounted directly to a substrate that carries other integrated circuits. For harsh environments, such as automotive applications, the ASIC is designed with sufficient tolerance and manufactured in such a manner that the ASIC can operate correctly over a temperature range and shock and vibration range required for automotive applications. For such applications, the on-chip peripheral devices provide control signals for drive-train control. The peripheral devices are controlled by processors that are periodically validated using an embodiment and checksum technique based on execution tracing described herein.

An ASIC embodying the invention may be included in a control module for controlling operation of an automobile, an airplane, industrial processing equipment, medical equipment, etc.

As used herein, the terms “applied,” “coupled,” “connected,” and “connection” mean electrically connected, including where additional elements may be in the electrical connection path. “Associated” means a controlling relationship, such as a memory resource that is controlled by an associated port.

It is therefore contemplated that the appended claims will cover any such modifications of the embodiments as fall within the true scope and spirit of the invention.

What is claimed is:

1. A method for detecting safe operation of a processor, the method comprising:
executing a sequence of instructions by a first processor;
tracing a portion of the execution to form a first sequence of trace data;
forming a first checksum from the first sequence of trace data;
comparing the checksum to a reference checksum; and
indicating an execution error when the first checksum does not match the reference checksum.

2. The method of claim 1, wherein the reference checksum is formed by:
executing the sequence of instructions by a known good processor;
tracing a portion of the execution to form a reference sequence of trace data;
forming the reference checksum from the reference sequence of trace data; and
storing the reference checksum for access by the first processor.

3. The method of claim 1, further comprising:
executing the sequence of instructions a second time by the first processor;
tracing a portion of the execution to form a second sequence of trace data;
forming a second checksum from the second sequence of trace data;
comparing the second checksum to the first checksum; and
indicating an execution error when the second checksum does not match the first checksum.

4. The method of claim 1, further comprising:
executing the sequence of instructions by a second processor;
tracing a portion of the execution to form a third sequence of trace data;
forming a third checksum from the third sequence of trace data;
comparing the third checksum to the first checksum; and
indicating an execution error when the third checksum does not match the first checksum.

5. The method of claim 4, wherein comprises comparing two or more checksums formed from two or more sequences of trace data from two or more processors.

6. The method of claim 4, wherein executing the sequence of instructions by the first processor and by the second processor is performed at diverse times.

7. The method of claim 6, wherein the diverse time is in a range of 0-50 ms.

8. A digital system comprising an integrated circuit, wherein the integrated circuit comprises:
at least one processing module operable to execute a program and to thereby generate hardware or software execution events for tracing;
a execution trace module connected to detect the execution events from the at least one processing module, wherein the execution trace module is operable to form trace data indicative of each execution event;
a checksum computation module coupled to receive the trace data, the checksum computation module being operable to compute a checksum that represents the trace data; and
comparison logic coupled to receive the checksum and to compare the checksum to a reference checksum.

9. The integrated circuit of claim 8, further comprising a checksum storage logic coupled to receive the checksum, wherein the comparison logic is configured to compare a first checksum from the checksum computation module to a second checksum generated by the checksum computation module.

10. The digital system of claim 8, wherein the integrated circuit comprises two or more processing modules, each having an execution trace module and a checksum computation module, wherein the comparison logic is coupled to receive and compare checksums generated simultaneously from the two or more processor modules.

11. The digital system of claim 8, further comprising a memory module coupled to the at least one processing module for holding the program; and a peripheral module coupled to the at least one processor, wherein the peripheral module is configured to provide a control signal for control of an automobile drive-train under control of the program in the memory module.
